(19) United States
(12) Patent Application Publication
(10) Pub. No.: US 2011/0298168 A1
(43) Pub. Date: Dec. 8, 2011

(54) SUSPENSION STRUT WITH ADJUSTABLE SPRING SUPPORT SYSTEM

(76) Inventor: Andreas Groebner, Waging am See (DE)

(21) Appl. No.: 12/793,519

(22) Filed: Jun. 3, 2010

Related U.S. Application Data
(60) Provisional application No. 61/351,207, filed on Jun. 3, 2010.

(51) Int. Cl. B60G 17/02; B60G 15/06; F16F 13/00

(52) U.S. Cl. 267/217

(57) ABSTRACT

In a suspension strut, the spring support system has a transmission system with a gearbox case and a drive gear that is mounted to rotate in the gearbox case. The adjustment nut, with which the prestressing of the spring can be set, is designed as a gear that works together with the drive gear, by which a rotation of the drive gear produces a screwing motion of the adjustment nut on the thread of the cylinder.

### CROSS-REFERENCES TO RELATED APPLICATIONS

This application claims the benefit of provisional application No. 61/351,207 filed Jun. 3, 2010, entitled “Federbein Mit Verstellbarer Federabstutzeinrichtung”, incorporated herein by reference.

This application is related to German application No. DE ______ entitled “Federbein Mit Verstellbarer Federabstutzeinrichtung” filed in the German Patent Office on Sep. 18, 2008 in the name of Andrew Groebner, and incorporated herein by reference.

### STATEMENT REGARDING FEDERALLY SPONSORED RESEARCH OR DEVELOPMENT

1. Field

The technology herein relates to a suspension strut for motor vehicles as well as a spring support system.

2. Background and Summary

Suspension struts of this type are used, for example, for elastic support of rear wheel swing arms of motorcycles and have, as is known, a combination of a shock absorber and a spring. The spring surrounds the shock absorber and is inserted by prestressing between two spring plates, of which one is fastened to the cylinder and the other is fastened to the piston rod of the shock absorber.

To be able to set and optionally also vary the suspension characteristics, it is known to design the spring plates that are arranged on the cylinder in the form of an adjustment nut that can be screwed onto an outside thread of the cylinder at different distances, by which the desired interval between the two spring plates and thus the spring prestressing can be set. The adjustment nut is usually secured by means of a counter nut. It is disadvantageous in this connection, however, that because of the high pressure that the spring exerts on the adjustment nut, the adjustment can be achieved only with difficulty and with special tools. In addition, it is often possible that when the adjustment nut is not properly secured against rotation, an unintended adjustment of the adjustment nut occurs.

The technology herein provides a suspension strut of the initially mentioned type in which the setting and the adjustment of the spring prestressing can be done in a simple and quick way.

With the suspension strut herein, the spring support system has a transmission system with a gearbox case and a drive gear that is mounted to rotate in the gearbox case. In addition, the adjustment nut is designed as a gear that works together with the drive gear in such a way that a rotation of the drive gear produces a screwing motion of the adjustment nut on the thread of the cylinder.

By means of the spring support system herein, the spring prestressing can be performed in a simple and quick way. The spring support device can be configured in such a way that it can be retrofitted with existing suspension struts without having to change the suspension struts themselves. The transmission system can easily be designed in a self-inhibiting way, i.e., because of the design and the transmission ratio of the transmission, no independent rotation of the adjustment nut is possible and additional rotation-prevention devices can be eliminated.

According to an advantageous embodiment, the gearbox case has a holding sleeve that extends around the cylinder and a bearing housing for mounting the drive gear that extends radially outward from the holding sleeve. Such a circumferential holding sleeve makes possible in a simple way the securing of the gearbox case on the cylinder.

According to an advantageous embodiment, the holding sleeve has a front wall that engages below the adjustment nut and on which the spring rests, in such a way that the spring force is transferred via the holding sleeve to the adjustment nut. By means of the front wall, the holding sleeve and thus the entire gearbox case are clamped firmly between the spring and the adjustment nut, by which the gearbox case is immobilized on the adjustment nut in a simple way in axial direction of the shock absorber.

According to an advantageous embodiment, the shock absorber has an oil compensating tank that is tightly connected to the cylinder, whereby the gearbox case is supported on the oil compensating tank in a torque-proof manner. This makes possible an simple embodiment, since an already existing part, namely the oil compensating tank, is used to secure the gearbox case against rotation relative to the shock absorber.

In this case, it is advantageous when the bearing housing is arranged between the cylinder and the oil compensating tank and has a support surface that is matched to the outside shape of the oil compensating tank for torque-proof support of the gearbox case. This makes possible a space-saving and simple arrangement of the spring support system.

As an alternative to the previously mentioned oil compensating tank or for the case that the suspension strut does not have any oil compensating tank, it is also possible that a projecting element that extends radially outward from the cylinder is fastened to the cylinder, and the gearbox case is supported in a torque-proof manner on the projecting element. Such a projecting element can be, for example, an element that is subsequently fastened on the cylinder or an element that is designed integrally with the cylinder.

According to an advantageous embodiment, the gearbox case can be moved in the longitudinal direction of the cylinder. Thus, it can be ensured in a simple way that the gearbox case always moves with the adjustment nut in axial direction in such a way that it can always be held at the same height with the adjustment nut. The relative position between drive gear and adjustment nut is thus always the same.

According to an advantageous embodiment, the drive gear consists of an adjustment spindle that has a screw, and the adjustment nut consists of a worm gear that is engaged with the screw. In this respect, in a simple way, on the one hand, a space-saving, and, on the other hand, a self-inhibiting arrangement can be provided that prevents the adjustment nut from rotating independently.

### BRIEF DESCRIPTION OF THE DRAWINGS

Exemplary illustrative non-limiting implementations are explained in more detail below based on drawings by way of example. Here:

FIG. 1 shows a suspension strut;

FIG. 2 shows the spring support system in an exploded view;

FIG. 3 shows a view that is similar to FIG. 2, whereby the adjustment nut is depicted broken down into its individual parts;

FIG. 4 shows a side view of the spring support system;

FIG. 5 shows a top view on the spring support system of FIG. 4; and

FIG. 6 shows a sectional view along the line VI-VI.

### DETAILED DESCRIPTION

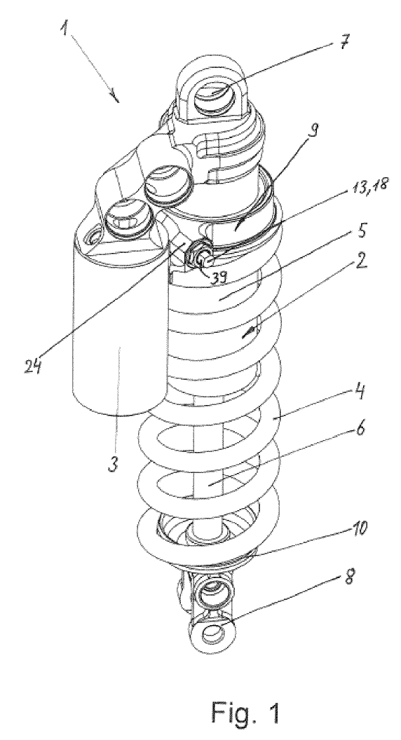

From FIG. 1, a suspension strut can be seen that can be used, for example, for elastic support of rear wheel swing arms of motorcycles.

The suspension strut 1 has a shock absorber 2 with a hydraulic action and with an oil compensating tank 3 as well as a spring 4 in the form of a spiral spring that surrounds the shock absorber 2.

The shock absorber 2 usually consists of a cylinder 5 (cylinder liner) in which a piston, not shown in more detail, can move back and forth. The movement of the piston is damped by oil, which flows through corresponding oil channels that are present in the cylinder 5 and that, on the one hand, discharge into a piston receiving space of the cylinder 5 and, on the other hand, into the oil compensating tank 3. The piston is connected in a known way to a piston rod 6 that projects downward via the cylinder 5.

On its upper end, the cylinder 5 has a fastening lug 7 for fastening to a frame part. On the lower end of the piston rod 6, a fastening fork 8 is arranged in the usual way to fasten the piston rod 6 to the rear wheel swing arms.

The spring 4 is supported on its upper end on a spring support system 9 and on its lower end on a spring plate 10. The spring support 9 is, as is explained in still more detail below, secured on the cylinder 5 while the spring plate 10 is fastened on the lower end of the piston rod 6 in the vicinity of the fastening fork 8. The distance between the spring support system 9 and the spring plate 10 is dimensioned in such a way that the spring 4 is inserted in between with prestressing. In addition, as can be seen from FIG. 1, the spring support system 9 is located at such a height relative to the cylinder 5 that it lies beside the upper end of the oil compensating tank 3 and extends through the intermediate space that the oil compensating tank 3 leaves to the cylinder 5 so that the spring 4 that is also beside the oil compensating tank 3 can extend upward along the cylinder 5.

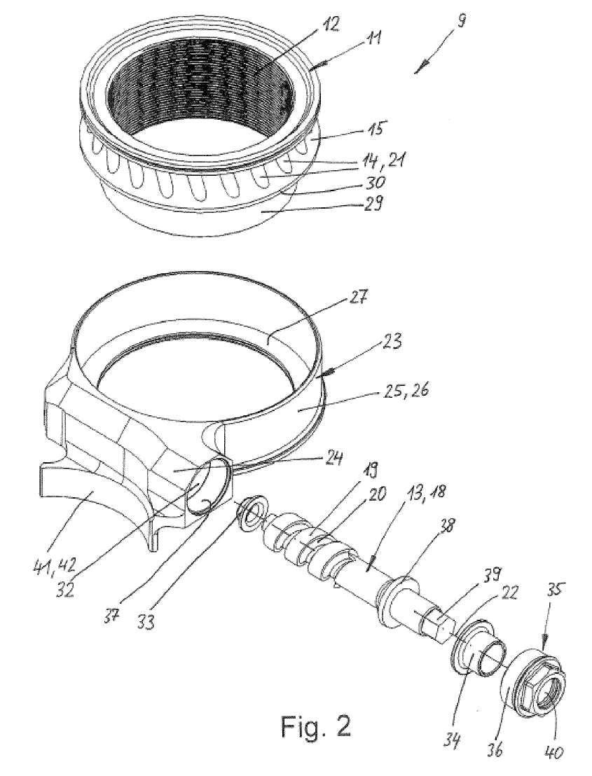

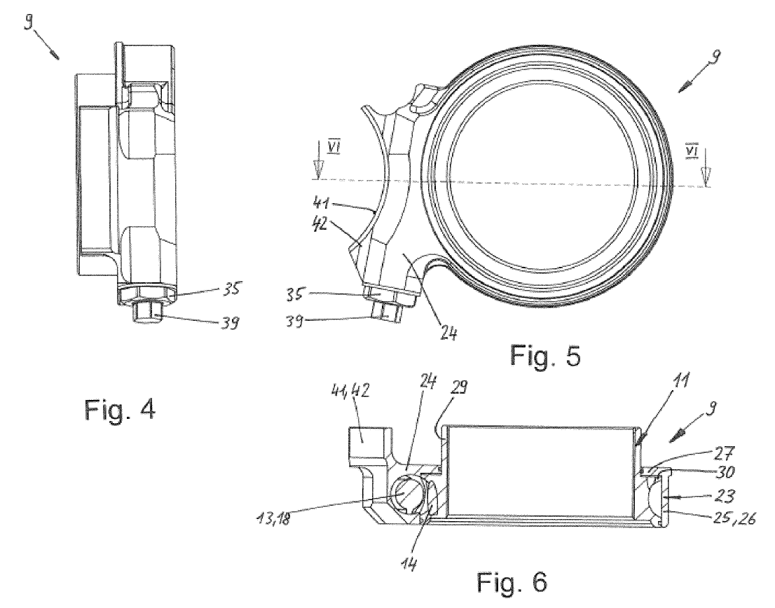

So that the spring prestressing can be set and optionally changed, the spring support system 9 can be secured in various positions along the cylinder 5. For this purpose, the cylinder 5 has an outside thread, not depicted in more detail, and the spring support system 9 has an adjustment nut 11 (FIGS. 2-6), which has a corresponding inside thread 12 and can be screwed onto the outside thread.

So that the adjustment nut 11 can be put into a screwing motion, it is designed as a gear with an external toothing 21, which is engaged with a drive gear 13. The external toothing of the adjustment nut 11 comprises teeth 13 that together produce an external gear rim. This gear rim extends in the depicted embodiment only over approximately half the axial length (height) of the adjustment nut 11. Alternatively, however, it is also easily possible to design the gear rim with a different height.

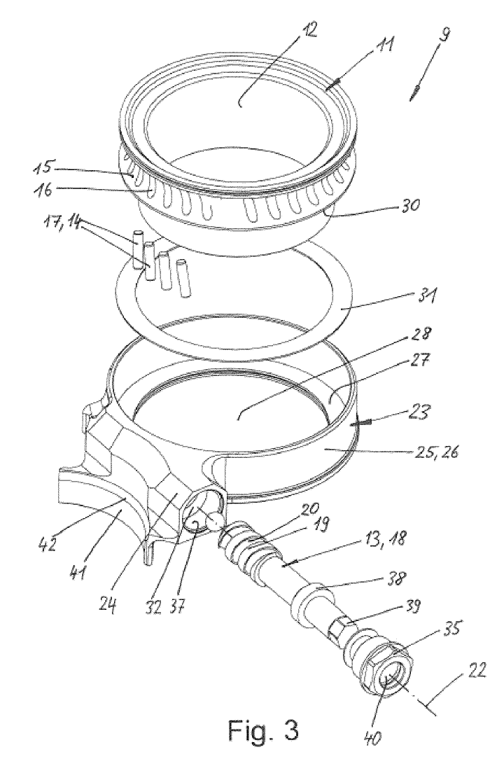

The toothing can be produced in a relatively simple way in that, as shown in FIG. 3, the adjustment nut 11 has an outside peripheral surface in its toothing section 15 that is curved like a C in cross-section and has longitudinal recesses 16 into which the cylindrical pins 17 can be inserted. FIG. 2 shows the adjustment nut 11 in the mounted state of the cylindrical pins 17.

As can be seen from FIGS. 2 and 3, the drive gear 13 consists of a rod-like adjustment spindle 18, on which a screw with a screw thread 20 is formed. The screw thread 20 is engaged with the external toothing 21 of the adjustment nut 11 in such a way that a rotation of the adjustment spindle 18 around its longitudinal axis 22 produces a rotation of the adjustment nut 11 around the longitudinal axis of the cylinder 5.

The adjustment spindle 18 is mounted to rotate in a gearbox case 23 and secured axially. To this end, the gearbox case 23 has a bearing housing 24 that accommodates the adjustment spindle 22 and a holding sleeve 25, with which the gearbox case 23 is held on the adjustment nut 11 and thus on the cylinder 5 of the shock absorber 2.

The holding sleeve 25 has a cylindrical pipe section 26 and a lower front wall 27, which is designed in the shape of a circular ring and extends radially inward from the lower end of the pipe section 26. The front wall 27 flows around a circular opening 28. The diameter of this opening 28 is dimensioned in such a way that a lower cylindrical section 29 of the adjustment nut 11 can be guided through the opening 28 with a small lateral play. In this connection, the toothing section 15 of the adjustment nut 11 goes into the area that is surrounded by the pipe section 26. The holding sleeve 25 and the adjustment nut 11 can be inserted into one another until a diameter shoulder 30 of the adjustment nut 11, which is present in the transition area between the lower section 29 and the toothing section 15 that is larger in diameter, comes to lie on the front wall 27 in such a way that the gearbox case 23 is supported in axial direction upward from the diameter shoulder 30.

Since, during rotation of the adjustment nut 11 relative to the torque-proof gearbox case 23, the result is a relative movement between these two elements, a friction-reducing intermediate ring 31, which preferably consists of plastic, is arranged between the diameter shoulder 30 and the front wall 27.

The gearbox case 23 is pressed against the diameter shoulder 30 of the adjustment nut 11 by means of the upper end of the spring 4 in such a way that the holding sleeve 25 is clamped between the adjustment nut 11 and the spring 4 and so that it is secured axially to the adjustment nut 11.

The bearing housing 24 for the adjustment spindle 22 is formed essentially tangentially to the holding sleeve 25, extends somewhat outward radially from the latter, and has a bearing bore 32 for accommodating the adjustment spindle 18. The longitudinal axis 22 of the bearing bore 32 and thus that of the adjustment spindle 18 thus runs perpendicular to the longitudinal axis of the shock absorber 2. At the front end, the adjustment spindle 18 is mounted to rotate in the bearing bore 32 by means of a bearing bush 33 and in a rear end area by means of a bearing bush 34. A closing cap 35 with a bearing ring 36 can be screwed into an end area 37 of the bearing bore 32. A diameter heel 38 of the adjustment spindle 22 rests axially on the bearing bush 34, by which the adjustment spindle 22 is secured in an axial direction. The axial securing of the adjustment spindle 18 is carried out in the opposite direction via the bearing bush 33.

The bearing housing 24 is opened to the adjustment nut 11 in such a way that the screw 19 goes into the area of the external toothing 21 of the adjustment nut 11 and engages with the teeth 14.

In order to be able to rotate the adjustment spindle 18, it has a multi-edge pin 39 on the rear end, and said pin is designed as a hexagon in the embodiment that is shown. This multi-edge pin 39 extends in the mounted state through a bore 40 of the connecting cap 35 and axially over the latter, in such a way that a screw wrench or a similar tool can be mounted on the multi-edge pin 39, and the adjustment spindle 18 can be rotated. Because of the transmission ratios of the transmission system, this is possible in a very easy and simple way.

The torque-proof support of the gearbox case 23 relative to the shock absorber 2 is carried out on a support surface 41, which is designed on the outside of the bearing housing 24. The support surface 41 is curved in the shape of a circular arc, whereby the radius is matched to that of the oil compensating tank 3, on which the support surface 41 rests. The support element 42 that has the support surface 41 thus forms a type of clasp that partially surrounds the oil compensating tank 3 and prevents the gearbox case 23 from turning tightly. Since the support surface 41 rests only loosely on the oil compensating tank 3, at the same time, however, an axial movement of the gearbox case 23 relative to the cylinder 5 is possible when the adjustment nut 11 is rotated by means of the adjustment spindle 18 and thus is moved along the cylinder 5.

As can be seen in the embodiment that is shown, the bearing housing 24 and the support element 42 are arranged in the intermediate space between the cylinder 5 and the oil compensating tank 3. In this case, a very space-saving arrangement is made possible. However, it is also easily possible to fasten the bearing housing 24 at a different point on the holding sleeve 25, for example in a position relative to the holding sleeve 25 that is rotated by 90° in comparison to FIG. 1.

The worm gear pair that is shown in the embodiment offers the advantage that it can be made very small and it is a self-inhibiting gear, so that additional rotation-prevention devices for the adjustment nut 11 are not necessary. Other gears are also conceivable, however, for example pure mitre gears or spur gears, optionally by means of additional locking devices.

While the technology herein has been described in connection with exemplary illustrative non-limiting implementations, the invention is not to be limited by the disclosure. The invention is intended to be defined by the claims and to cover all corresponding and equivalent arrangements whether or not specifically disclosed herein.

We claim:

1. Suspension strut for motor vehicles, comprising:
a shock absorber that has a cylinder and a piston rod,
a spring support system that has an adjustment nut that can be screwed onto a thread of the cylinder,
a spring plate that is fastened to the piston rod,
a spring that is arranged between the spring support system and the spring plate,
the spring support system having a transmission system with a gearbox case and a drive gear that is mounted to rotate in the gearbox case and in that the adjustment nut is designed as a gear that works together with the drive gear in such a way that a rotation of the drive gear produces a screwing motion of the adjustment nut on the thread of the cylinder.

2. Suspension strut of claim 1, wherein the gearbox case has a holding sleeve that extends around the cylinder and a bearing housing that extends radially outward from the holding sleeve for mounting the drive gear.

3. Suspension strut according to claim 2, wherein the holding sleeve has a front wall that engages below the adjustment nut and on which the spring rests, in such a way that the spring force is transferred via the holding sleeve to the adjustment nut.

4. Suspension strut according to claim 1, wherein the shock absorber has an oil compensating tank that is tightly connected to the cylinder and the gearbox case is supported on the oil compensating tank in a torque-proof manner.

5. Suspension strut according to claim 4, wherein the bearing housing is arranged between the cylinder and the oil compensating tank and has a support surface that is matched to the outer shape of the oil compensating tank for torque-proof support of the gearbox case.

6. Suspension strut according to claim 1, wherein a projecting element that extends radially outward from the cylinder is fastened to the cylinder, and the gearbox case is supported in a torque-proof manner on said projecting element.

7. Suspension strut according to claim 1, wherein the gearbox case can be moved in the longitudinal direction of the cylinder.

8. Suspension strut according to claim 1, wherein the drive gear consists of an adjustment spindle that has a screw, and the adjustment nut consists of a worm gear that is engaged with the screw.

9. Spring support system for a suspension strut according to claim 1.
